(19) United States
(12) Patent Application Publication
(10) Pub. No.: US 2021/0284809 A1
(43) Pub. Date: Sep. 16, 2021

(54) Cure Device and Method

(71) Applicant: 3D RESIN SOLUTIONS, LLC, South Elgin, IL (US)

(72) Inventor: Craig Richard Tinerella, Elburn, IL (US)

(21) Appl. No.: 17/193,981

(22) Filed: Mar. 5, 2021

Related U.S. Application Data
(60) Provisional application No. 62/990,075, filed on Mar. 16, 2020.

(51) Int. Cl. C08J 3/28

(52) U.S. Cl. CPC C08J 3/28; C08J 2300/12

(57) ABSTRACT

A cure device is disclosed for curing photopolymer in a container. The device has a cap and a probe. The probe extends from the cap. The probe has a plurality of cure lights. The device may have a container sensor positioned to detect the presence of a container at the cap.

This application claims the benefit of U.S. Patent Application No. 62/990,075, filed Mar. 16, 2020.

### FIELD OF THE INVENTION

This invention relates in general to cure devices.

### BACKGROUND OF THE INVENTION

Liquid photopolymer is used in certain 3D printing, flexographic printing, other printing, dentistry fillings, and floor coatings among other applications. Liquid photopolymer is often supplied in containers. When the container is mostly empty of liquid photopolymer such that the user desires to dispose of the container, the container often contains at least some amount of residual liquid photopolymer. Liquid photopolymer is usually hazardous to human skin and the environment.

However, liquid photopolymer is a substance that often requires special disposal or recycling process(es) and cannot or should not be thrown out in the general trash, dumped on the ground, or down the drain.

The present inventor recognized that cutting the photopolymer container open to cure the remaining photopolymer inside the container by exposing the photopolymer to sunlight UV radiation, is burdensome and time consuming. Further the present inventor recognized that washing out the container to remove the liquid uncured photopolymer, adds steps, time, and expense, and can create more potentially hazardous waste and emit volatile organic compounds.

The present inventor recognized the need for an improved device and method for disposing of used photopolymer containers. The present inventor recognized the need for a device to cure residual photopolymer in used or mostly empty supply photopolymer containers. The present inventor recognized the need for a cure device that a user can quickly, easily, and safely use to cure residual photopolymer remaining in a used container, which avoids human touching the liquid photopolymer, washing the container, or cutting the container open.

### SUMMARY OF THE INVENTION

A cure device is disclosed for curing photopolymer in a container. The device comprises a cap and a probe. The probe extends from the cap. The probe comprises a plurality of cure lights. The device may comprise a container sensor positioned to detect the presence of a container at the cap.

A method of curing photopolymer in a container is disclosed. A probe of a cure device is inserted into an opening of the container. The opening is closed with the cap of the cure device. A plurality of cure lights on the probe are illuminated when a container sensor of cure device detects the container at the cap.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a front side view of a first embodiment cure device of the invention.

FIG. 2 is a back side view of the cure device of FIG. 1.

FIG. 3 is a bottom view of the cure device of FIG. 1.

FIG. 4 is a front side view of the cure device of FIG. 1 shown in a container.

FIG. 5 is a flow diagram of a cure function of the cure device of FIG. 1.

FIG. 6 is a circuit block diagram of a control circuit of an embodiment of the cure device of the invention.

FIG. 7 is a front side view of a second embodiment cure device of the invention.

FIG. 8 is a back side view of the cure device of FIG. 7.

FIG. 9 is a bottom view of the cure device of FIG. 7.

FIG. 10 is a front side view of a third embodiment cure device of the invention.

FIG. 11 is a bottom view of the cure device of FIG. 10.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, this description describes and the drawings show specific embodiments of the invention with the understanding that the present disclosure is to be considered as an exemplification of the principles of the invention and is not intended to limit the invention to the specific embodiments illustrated.

A cure device 10 is disclosed. The cure device comprises a cap 12 and a probe 14. The probe extends away from the cap. The cap 12 may act as a handle, providing one or more places to a user for grip, hold, and direct the placement of the device 10. In some embodiments, the cap 12 comprises a cap housing 13.

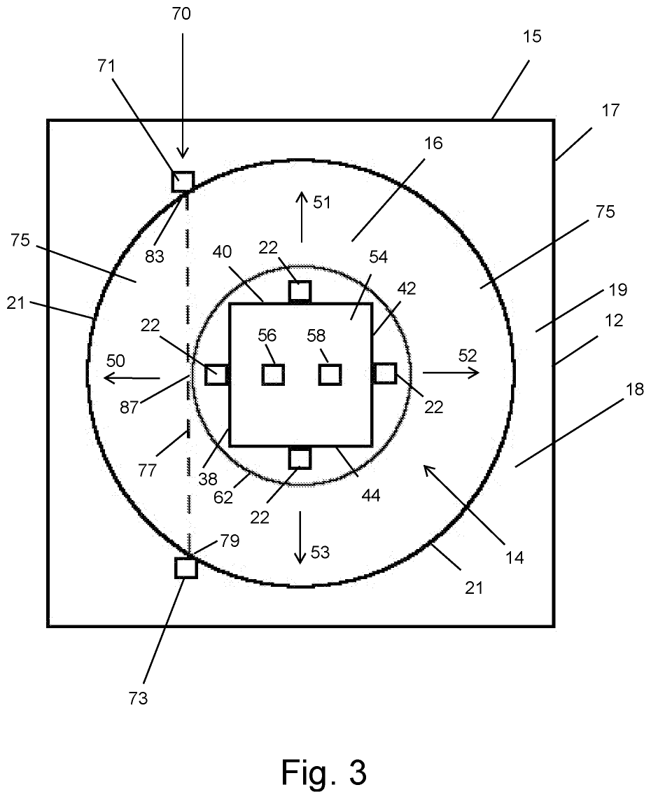

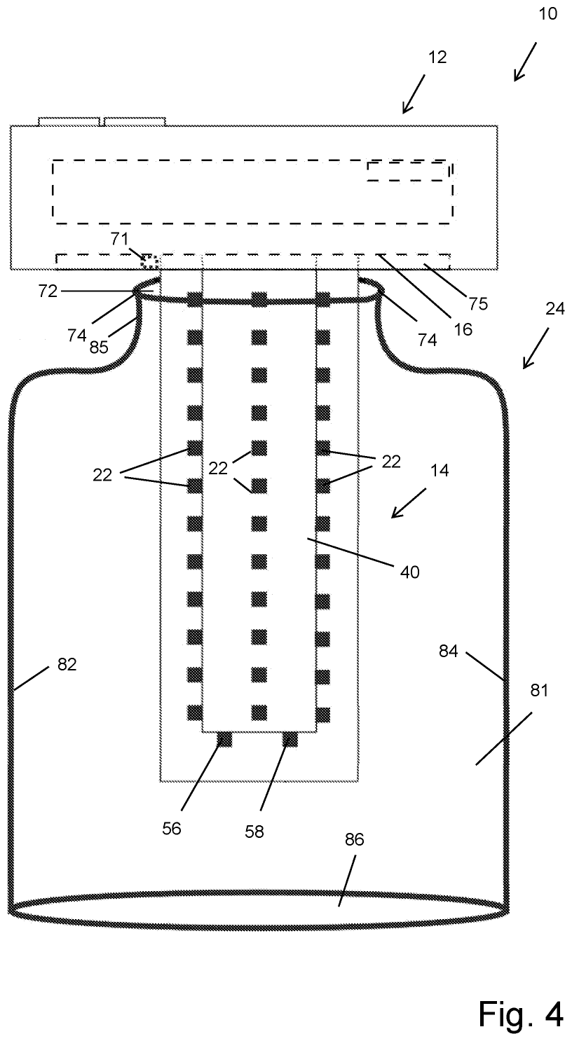

The cap comprises an engaging surface 16 for engaging the opening of a container, such as container 24 (FIG. 4). In some embodiments, the cap comprises a bottom recess 75, which comprises the engaging surface 16. In some embodiments, the recess 75 comprises a circular perimeter wall 21, as shown in FIG. 3. The engaging surface 16 is recessed from a bottom surface 19 of the bottom side 18. In some embodiments, the probe 14 extends from the engaging surface 16, or from the plane of the engaging surface, and through the bottom recess 75.

In some embodiments and applications, the container 24 is a bottle, jug, bucket, drum, or intermediate bulk container. In some embodiments and applications, the container can be a range of sizes and/or shapes. For example, in some embodiments and applications, the container could be 100 milliliters or less, or 30 gallons, or 225 gallons, or other sizes. In some applications, the vertical sides 82, 84 of the container 24 may be one continuous wall, such as if the container 24 has a cylindrical cross-section or otherwise curved side. The container 24 is shown transparently in FIG. 4 to illustrate the probe therein, but usually container is not transparent.

The probe 14 extends from a bottom side 18 of the cap 12. In some embodiments, the probe 14 is perpendicular to the cap. In some embodiments, the probe 14 is transverse to the cap. The bottom side 18 comprises the engaging surface 16.

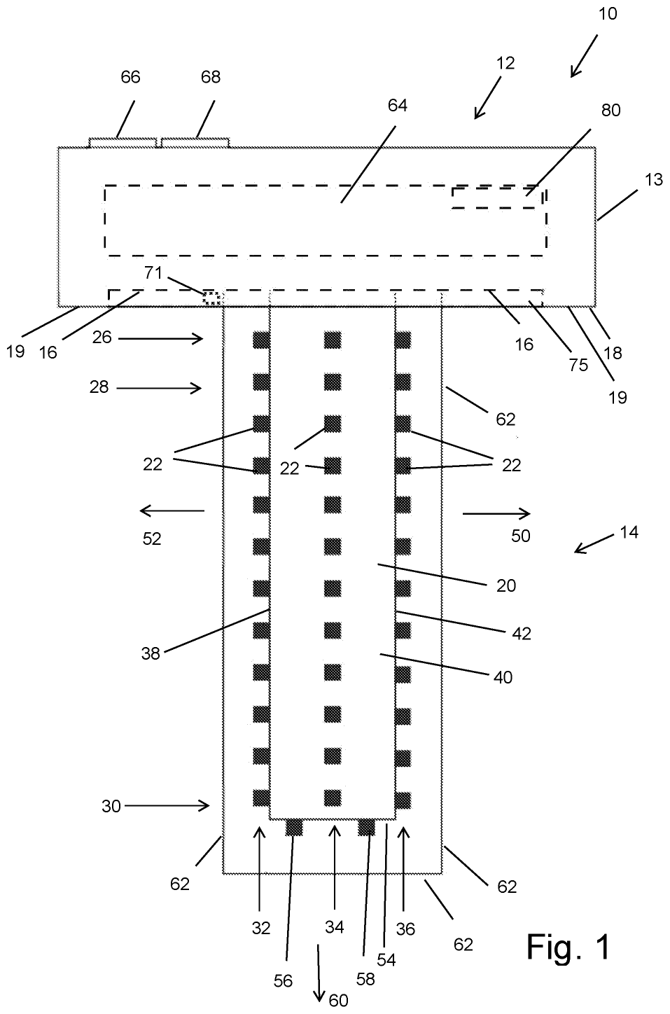

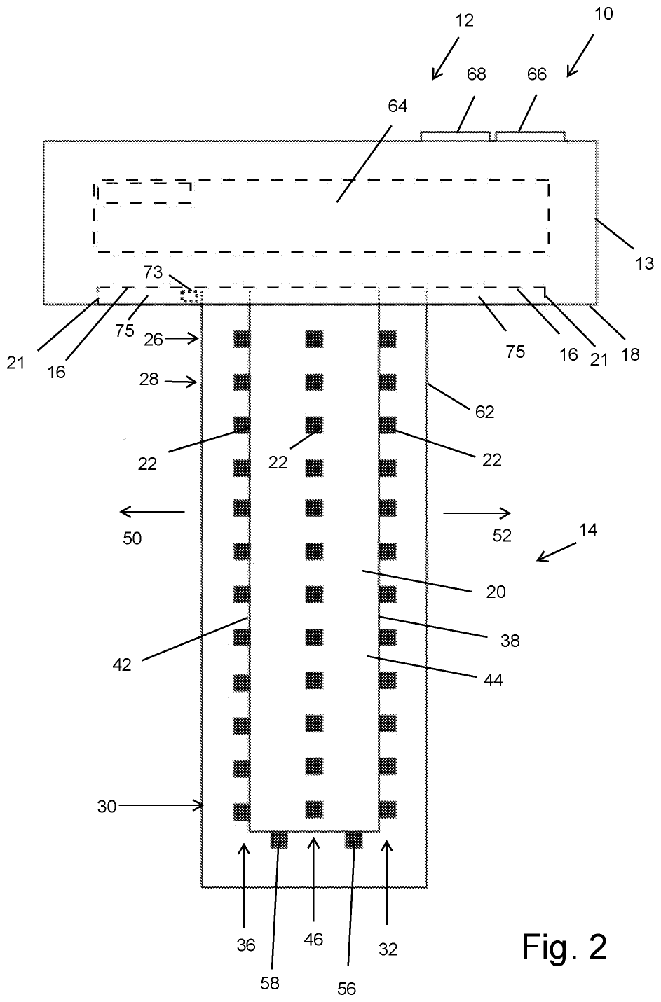

The probe 14 comprises a shaft 20. The shaft comprises a plurality of cure lights 22. In some embodiments, the shaft is elongated. In some embodiments, the lights 22 are arranged along a longitudinal extent on the shaft 20. In some embodiments, the lights are arranged and aligned in a plurality of rows 26, 28, 30 (the nine rows between row 28 and row 30 are not labeled) and a plurality of columns 32, 34, 36. Each row of the plurality of row has four cure lights, one on each of the longitudinal sides 38, 40, 42, 44. The cure lights of each row of the plurality of rows surround the shaft 20 at the same longitudinal level along the shaft. Therefore, for example, the cure lights 22 in row 26 are aligned at the same longitudinal level, as shown in FIGS. 1 and 2. As a further example, the cure lights 22 in row 28 are aligned in the same longitudinal level along the shaft. As a still further example, the cure lights 22 in row 30 are aligned in the same longitudinal level along the shaft.

In some embodiments, the shaft comprises a square or rectangular cross-section, comprising the four longitudinal sides 38, 40, 42, 44. The lights 22 in column 32 are mounted on side 38, the lights 22 in column 34 are mounted on side 40, the lights 22 in column 36 are mounted on side 42, the lights 22 in column 46 are mounted on side 44. Side 40 is opposite side 44. Side 38 is opposite side 42.

The lights 22 on the sides 38, 40, 42, 44 direct light away 50, 51, 52, 53 from the shaft. The direction includes light that is directed perpendicular from the longitudinal length of the shaft. The range of direction from the light is not limited to a perpendicular direction. The range of direction of the light from each of the lights 22 may include 90 degrees in each direction lateral and longitudinal direction from the center of each light 22 so as to cover a 180 degree range in each of the lateral and longitudinal direction about each light 22. As the lights are located on all longitudinal sides 38, 40, 42, 44 of the shaft, the light emitted from the lights 22 is emitted 360 degrees about the shaft.

In some embodiments, the bottom 54 of the shaft comprises one or more bottom cure lights 56, 58, which project light in a downward direction 60 from the shaft.

The cure lights 22, 56, 58 emit light when powered. In some embodiments, the cure lights 22, 56, 58, when powered, emit light having a wavelength in the range of 395 to 405 nanometers, inclusive. In some embodiments, the cure lights when powered, emit light having a wavelength in the range of 300 to 450 nanometers, inclusive. In some embodiments, the cure lights emit an ultraviolet light. Photopolymer can be formulated to comprise a photo initiator that reacts to light of a given wavelength or range of wavelengths to cure. The light emitted by the cure lights is capable of curing the photopolymer from liquid form into solid plastic. The cure lights 22, 56, 58 can be selected and/configured to emit a one or more wavelengths capable of curing the desired photopolymer(s).

In some embodiments, the probe 14 comprises a cover 62 that surrounds the shaft and is connected to the cap 12. The cover is transparent. The cover may comprise transparent glass or plastic. The light emitted from the cure lights 22, 56, 58 passes through the cover. In some embodiments, the cover protects the lights and the shaft from direct contact, impact, and damage.

The device 10 comprises a controller 64. The controller may be housed in the cap 12 or the probe 14. The controller is shown housed in the cap in the figures. The cap comprises a activate switch 66 connected to the controller. In some embodiments, the cap comprises a container sensor 70, at or adjacent the engaging surface 16, connected to the controller. In some embodiments, the cure lights 22, 56, 58 are also connected to the controller. In some embodiments, the cap comprises an active light 68 which is connected to the controller to indicate when the cure lights 22, 56, 58 are illuminated.

When the cap is seated at the container opening, the cap closes the opening and prevents light from the cure lights 22, 56, 58 from escaping through the opening of the container. In some embodiments, the cap is seated at the opening when the cap, such as at the engaging surface 16, is in contact with the lip or rim 74 about the opening 72.

In some embodiments, the device 10 comprises a power source 80, shown in FIG. 1. In some embodiments, the power source comprises one or more batteries. When batteries are used, the batteries can be rechargeable and should be sufficiently charged before use in the cure device. In some embodiments, the device 10 comprises a power connection, such as a wired connection, to an external power source, such as a wall power outlet, which may provide 110-volt or 220-volt power. The power source is connected to the controller and to the cure lights 22, 56, 58, and light 68 and provides power to the controller and to illuminate cure lights 22, 56, 58, and light 68.

The container sensor 70 is configured to detect the presence of a container at the cap, such that the cap closes the opening 72 of the container through which the probe is received. In some embodiments, the sensor is an optical sensor that detects the presence of the container at the cap. In some embodiments, the sensor is a photoelectric sensor that comprises an emitter 71 and a receiver 73. The emitter 71 is directed at the receiver 73, such as shown in FIG. 3, within the recess 75. The emitter emits an emitted light 77 toward the receiver 73. In some embodiments, the path of un-interrupted emitted light extends from a first side portion 79 of the recess 75 perimeter wall 21 to adjacent 87 the cover 62 of the probe 14 and to a second side portion 83 of the perimeter wall 21 opposite of the first side portion 79. In some embodiments the path of un-interfered emitted light 77 follows a line or a chord within the recess closely adjacent to, but without intersecting with the cover 62, as shown in FIG. 3.

The receiver 73 detects the emitted light 77 and also detects a change in the emitted light, such as a reduction or elimination of the emitted light being received at the receiver. For example, when the rim 74 of a container 24 is placed against the engaging surface 16 in the recess 75, the container will block the emitted light from reaching the receiver 73 or it will reduce the amount or otherwise change the emitted light that might reach the receiver. In some application, it is the rim 74 or the neck 85 of the container blocks the emitted light from reaching the receiver 73.

This lack of emitted light or reduction in the emitted light reaching the receiver is detected by the receiver. Therefore, the state of the emitted light received at the receiver is known to the receiver. The change of the state of received light at the receiver will also be known by the receiver. The state changes include from un-interfered to interfered, and from interfered to un-interfered. The interfered state includes when a container, such as the rim 74/neck 85, is within the recess and in the path of the emitted light. The interfered state includes when a container is not within the recess in the path of the emitted light. In some embodiments, when a state change occurs it will be communicated by the receiver to the controller, such as by a predefined electrical output or signal. In some embodiments, the current state is continuously or at regular intervals communicated to the controller. The controller recognizes a first predefined electronic output or signal from the receiver as indicating a container is present in the recess 75 or that there is a lack of or a reduction of emitted light reaching the receiver. The controller recognizes a second predefined electronic output or signal from the receiver as indicating a container is absent from the recess 75 or that the emitted light is un-interfered. In some embodiments, the emitter emits an infrared or visible light, detectable by the receiver.

In some embodiments, the emitter 71 is an emitter and receiver and receiver 73 is a reflector. The emitter/receiver detects light emitted by the emitter portion that is reflected back to the emitter/receiver from the reflector. The emitter/receiver detects a change in state when the reflected emitted light received by the receiver has changed such as when an object blocks or reduces the emitted light from reaching the reflector or the perimeter wall opposite of the emitter/receiver. The change of the state of received light at the emitter/receiver will also be known to the emitter/receiver. The state changes include from un-interfered to interfered, and from interfered to un-interfered. In some embodiments, when a state change occurs it will be communicated by the emitter/receiver to the controller, such as by a predefined electrical output or signal. In some embodiments, the current state is continuously or at regular intervals communicated to the controller. The controller recognizes a first predefined electronic output or signal from the receiver as indicating an interfered state where a container is present in the recess 75 or that there is a lack or reduction of emitted light reaching the receiver. The controller recognizes a second predefined electronic output or signal from the receiver as indicating a container is absent from the recess 75 or that the emitted light is un-interfered. In some embodiments, the emitter/receiver emits an infrared or visible light, detectable by the emitter/receiver. In some embodiments, a reflector is not used, and the emitter/receiver detects emitted light reflected from the perimeter wall opposite of the emitter/receiver.

When the probe is placed within the opening 72 of the container 24 and the cap is seated covering the container opening, the container sensor will detect the container 24, such as the rim 74 or neck 85 of the container. Based on the output or signal from the container sensor indicating the presence of a container in the recess at the cap, such as an output or signal indicating an interfered state, the controller recognizes that the cap is seated to close the opening of the container and permits the illumination of the cure lights 22, 56, 58 if the device is in an on-state. The controller is configured to prevent the illumination of the cure lights 22, 56, 58 if the container sensor 70 does not detect the presence of a container, such as when the sensor reports an un-interfered state, at the cap and also if the device is in an off-state.

In some embodiments, the container sensor is a contact sensor where the container sensor will be engaged by the rim 74 of the opening 72 of the container when the probe is placed within the opening of the container and the cap is seated covering the container opening. In some embodiments, the container sensor is located on the engaging surface 16 of the recess 75 such that it contacts the rim 74 of the opening 72 when the cap is seated at the opening. In some embodiments, the container sensor 70 comprises a spring biased button that is engaged and depressed by contact with the rim 74. The container sensor sends an output or signal to the controller when the sensor detects a presence of a container within the recess 75 at the cap, such as when the contact sensor is depressed. Based on the output or signal from the container sensor indicating the presence of a container within the recess 75, the controller recognizes that the cap is seated to close the opening of the container and permits the illumination of the cure lights 22, 56, 58 if the device is in an on-state. The controller is configured to prevent the illumination of the cure lights 22, 56, 58 if the container sensor does not detect the presence of a container, such as when the contact sensor is not depressed, at the cap and also if the device is in an off-state.

In some embodiments, the controller monitors the output or signal from the activate switch 66. The controller sets the power state of the device 10 to an on-state when an output or signal is received from the switch 66 and the immediate prior state was an off-state. The controller sets the power state of the device to an off-state when an output or signal is received from the activate switch 66 and the immediate prior state was an on-state. Therefore, the device will have an on-state when the activate switch 66 is pushed and the device, prior to the activate switch being pushed, was in an off-state. The device will stay in an on-state until the activate switch is again pushed, at which point the device will have an off-state.

In some embodiments, the switch 66 is a switch that has an on position and an off position. The device 10 will be in an on-state when the switch is in the on position. The device 10 will be in an off-state when the switch is in an off position.

A use of the device 10 is to cure liquid photopolymer in a container. The container 24 comprises photopolymer in an interior 81 of the container 24. For example, in some applications, the container may be mostly empty of liquid photopolymer such that the user desires to dispose of the container, but the container contains at least some amount of residual liquid photopolymer. In some applications, the photopolymer is an ultraviolet photopolymer.

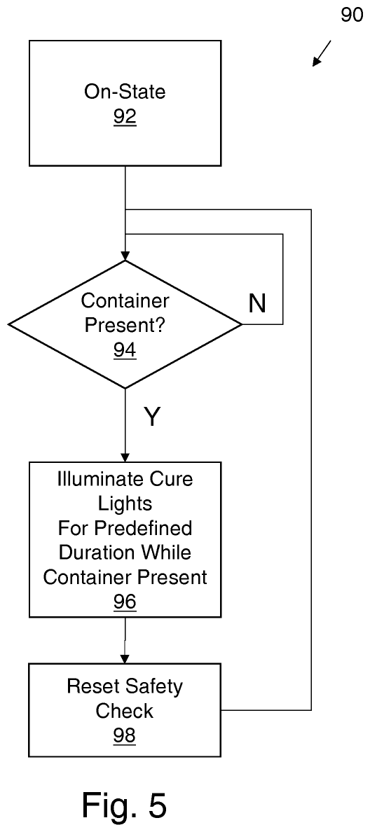

FIG. 5 shows a cure function 90 of the device 10, which may be executed by the controller 64. At step 92, the device is in or is caused to be in an on-state, such as caused by the activate switch 66 being or have been pressed or the switch 66 is otherwise placed in the on position. When the device is in the on-state the controller will proceed to step 94. At step 94, the controller determines whether the container sensor 70 indicates the presence of a container at the cap, such as by receiving a present output/signal or an interfered output/signal from the container sensor 70. In some embodiments, the sensor will indicate the presence of a container, when the probe 14 is inserted through the container opening, such as opening 72, and the engaging surface 16 of the cap is contacting the rim 74 and the cap is closing the opening 72.

If the controller determines the container sensor 70 indicates a container is not at the cap, then the controller does not illuminate the cure lights and the controller stays at or returns to step 94 to check again whether the container sensor 70 indicates the presence of a container at the cap. In some embodiments, when the container sensor 70 does not detect the presence of a container at step 94, the controller waits for an interrupt indicating that the container is detected by the sensor 70. In some embodiments, when the container is not detected by the container sensor 70 at step 94, the controller waits a predefined time before checking again whether the container is detected by the container sensor 70. Therefore, the controller can be configured to wait for an interrupt or check at intervals whether the container is detected by the container sensor 70.

When the controller determines that the container sensor 70 detects a container present, the cure function 90 proceeds to step 96, where the controller causes the cure lights 22, 56, 58 to turn on and illuminate by power from the power source 80 or an external power source.

In some embodiments, the controller causes the cure lights 22, 56, 58 to illuminate for a predefined duration of time at step 96. In some embodiments, the predefined duration is 15 seconds, but other predefined times can be used. The controller can be configured so that the predefined duration corresponds to the duration of time sufficient for the light from the cure lights to cure a given type and/or quantity of photopolymer within the container where the cure device is deployed or to be deployed. The light emitted from the cure lights 22, 56, 58 causes a reaction with the photopolymer in the container which cures the hazardous liquid photopolymer into solid nonhazardous plastic which can then be properly and safely disposed of. The photopolymer is often cured solid to a one or more sides 82, 84, 86 of the container 24. The cure lights are not powered or are turned off by the controller at the end of the predefined duration of time.

During the predefined duration at step 96, the controller monitors for input from the container sensor 70. If the container sensor 70 outputs/signals to the controller and an un-interfered state or lack of container presence at the cap, the controller will terminate or stop the illumination of the cure lights, as a container sensor caused termination of the cure lights. The un-interfered state or lack of container presence at the cap may occur when there is a a loss of contact between engagement surface of the cap and the container or the container does not interfere with or obstruct the light emitted from the emitter of the sensor 70. If a container sensor caused termination of the cure lights results at step 96, the function will return to step 94 and wait until the container sensor to again indicate the container is present at the cap, such as when the sensor indicates an interfered state.

In some embodiments, the controller resets a safety check at step 98. In some embodiments, the safety check reset occurs when the container sensor 70 does not detect the container presence at the cap after detecting the presence of a container at step 96. When a container is not detected, then the function proceeds to step 94 to wait until the container sensor 70 next detects the presence of a container at the cap when the device is in an on-state.

When the predefined duration of time of cure light illumination is ended, the user can withdraw the probe out of that container and move the device to deploy the probe in the next container with a photopolymer to be cured. Therefore, the container sensor 70 can act as a cure light illumination switch while the device is in an on-state. Each time the container sensor 70 is engaged at the opening of the respective container, while the device is in an on-state, the cure lights will be activated for the predefined duration of time.

In some embodiments, the controller will indicate to a user, such as via light 68, that the cure light predefined duration of time of illumination is ended. In some embodiments, the light 68 is illuminated when the cure lights are illuminated and the light 68 is not illuminated when the predefined time is expired so that the user knows when the curing is complete. In some embodiments, the light 68 flashes on and off when the cure lights are illuminated and the light 68 is steady, non-flashing, illuminated when the predefined time is expired and the cure lights are off, and therefore the user knows curing is complete within the container.

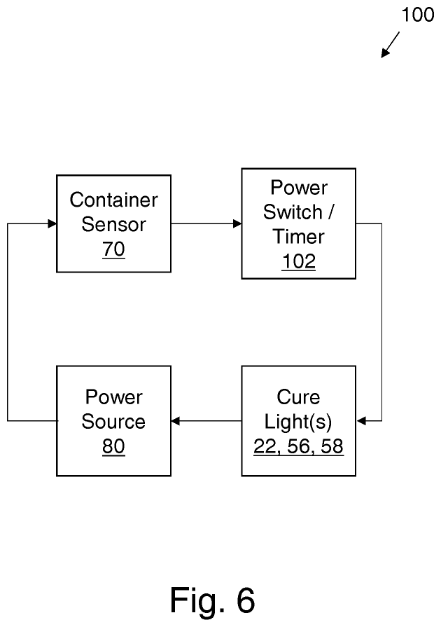

FIG. 6 shows a control circuit 100 diagram. The circuit 100 is for use in device 10 where the control circuit provides a controller function and the timer and the container sensor in the provided configuration act as or in place of the controller 64. The container sensor 70 controls the power from the power source 80. If the container sensor indicates a container is present at the cap, then power is allowed to pass to the power switch and timer 102.

If power reaches the power switch and timer 102, and the device is in an on-state, then the timer 102 will begin and allows power to pass to the cure lights 22, 56, 58 for a predefined duration of time. When the predefined duration of time expires, the timer stops allowing power from the power source to pass to the cure lights. The timer will against start if a container is detected by the container sensor and the device is in an on-state. The timer may be configured to wait for an interrupt in power from the container sensor before starting the timer so that the container sensor detects a subsequent container and the timer does not immediately restart on the same container.

If the predefined duration has not expired and the timer loses power because the container sensor does not detect a container present at the cap, then the timer will reset to the beginning of the predefined duration and wait to receive power before beginning the timer. Therefore, the cure lights will be illuminated the full predefined duration after an interrupt in power or a loss of or lack of detection of the container by the container sensor.

In some embodiments, the cap can be set upon the rim 74 of the opening of the container 24, which sufficiently closes the container opening and prevents cure light from escaping from the opening. The cap may or may not be further secured to the rim and/or at the opening.

In some embodiments, the device 10 comprises a speaker (not shown) controlled by the controller or the timer. The speaker can create a sound audible to the human ear at certain stages of operation of the device 10, such as during the cure function 90. For example, the speaker creates an audible sound, such as a one or more beeps, after the switch 66 is pressed or switched and when the device is in the on-state to indicate to the user that the device is ready for use in curing. In some embodiments, the speaker creates an audible sound, such as a one or more beeps, when the predefined duration expired at step 96 and therefore the curing is complete.

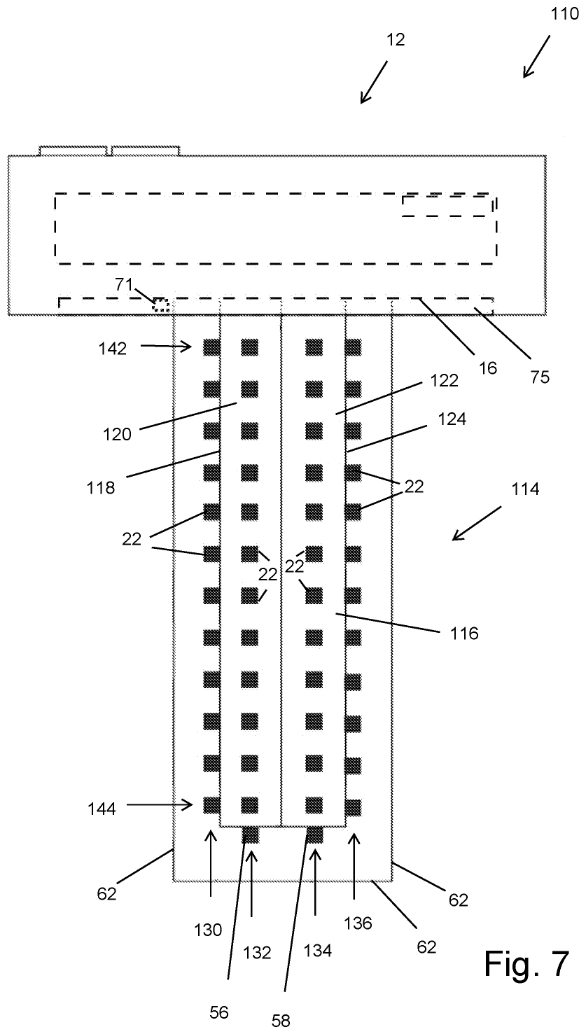

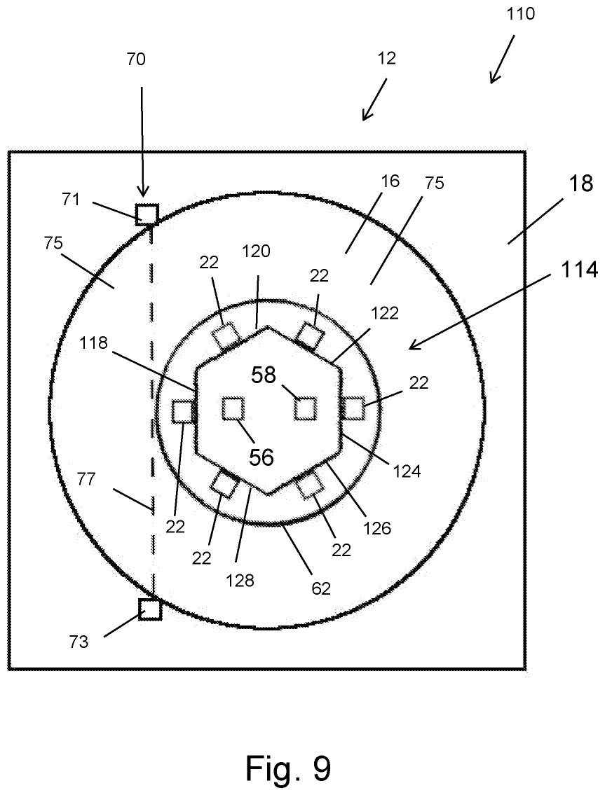

FIGS. 7 through 9 shows a second embodiment cure device 110. The device 110 is the same, and operates the same, as cure device 10 except that the probe 114 comprises shaft 116 with a hexagonal cross-section rather than a square or rectangular cross-section of shaft 20. The shaft 116 has two additional longitudinal sides as compared to shaft 20, each side comprising a column of cure lights. As shaft 116 has two additional longitudinal sides as compared to shaft 20, each row of cure lights of shaft 116 comprises cure lights at more positions about the shaft 116 at each longitudinal level, as compared to shaft 20.

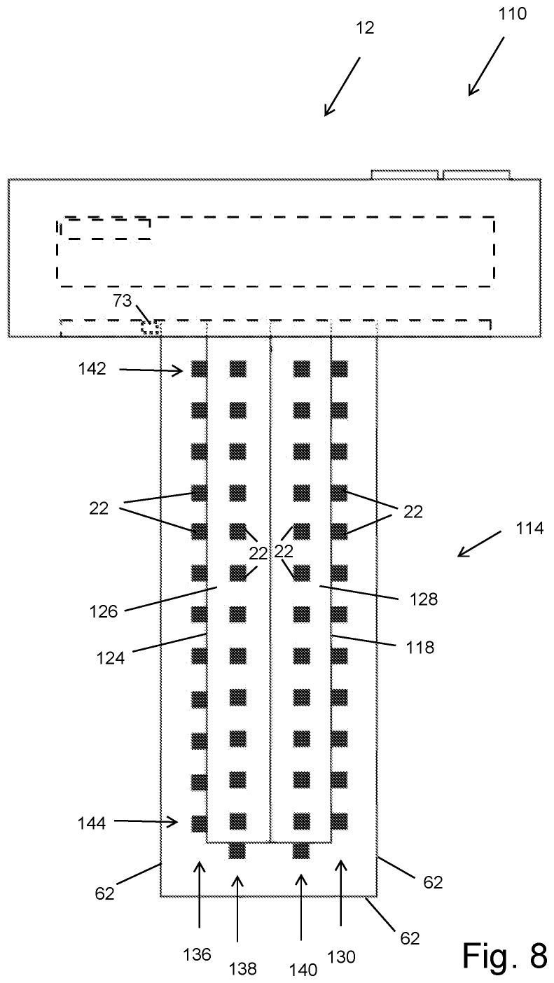

The shaft 116 of device 110 comprises longitudinal sides 118, 120, 122, 124, 126, and 128. In some embodiments, the plurality of cure lights 22 are arranged and aligned in columns 130, 132, 134, 136, 138, 140. Side 118 comprises column 130, side 120 comprises column 132, side 116 comprises column 134, side 124 comprises column 136, side 126 comprises column 138, and side 128 comprises column 140. The plurality of cure lights 22 are arranged and aligned in a plurality of rows 142, 144 (the 10 rows between 142 and 144 are not labeled in FIGS. 7 and 8). Each row has six cure lights, one on each of the longitudinal sides. The cure lights of each row of the plurality of rows surround the shaft 116 at the same longitudinal level along the shaft. Therefore, for example, the cure lights 22 in row 142 are aligned at the same longitudinal level, as shown in FIGS. 7 and 8. As a further example, the cure lights 22 in row 144 are aligned in the same longitudinal level along the shaft.

In some embodiments, the cap 12 comprises a length 15 of 2.25 inches and a width 17 of 2.25 inches (FIG. 3) . In some embodiments, the probe comprises a longitudinal length from the cap to the bottom 54 of 5 inches. In some embodiments, the probe comprises a longitudinal length from the cap to the bottom 54 of at least 4 inches. Other sizes are possible.

The cap 12 should be sized sufficient to cover the opening, such an as opening 72 of the container on which the cure device 10, 110 is to be used and to block light from escaping the opening. Blocking the light from the cure lights from escaping is to protect a user's eye and skin from harmful or unnecessary exposure to such light. The cap can be sized to cover wide-mouth openings of containers.

A method of making the cure device 10, 110 may include the following in this paragraph. Installing the probe on the cap. Connecting cure lights to the power source and controller. Installing the container sensor, and the controller in the cap. Installing switch 66 and light 68 in the cap and connected to the controller.

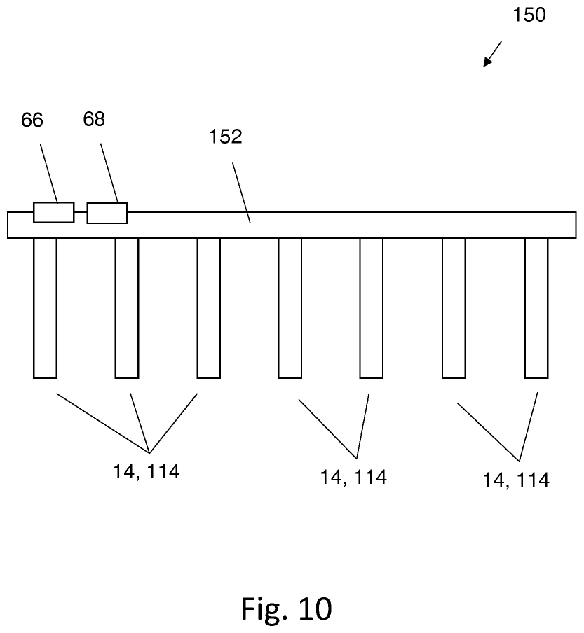

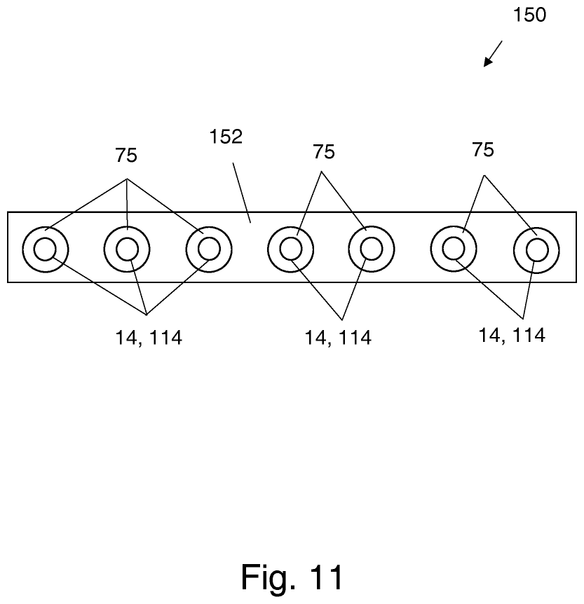

FIG. 10 shows a third embodiment cure device 150 comprising a plurality of probes 14, 114 and a cap 152. The probes may be probe 14, probe 114, or any other probe disclosed herein or a combination thereof. The cap 152 carries multiple probes. The cap comprises the controller 64 or circuit 100 for controlling the cure lights 22, 56, 58 of the probes. In some embodiments, the cap 152 comprises a recess 75 at each probe on a bottom of side of the cap as shown in FIG. 11. In some embodiments, the cap 152 comprises container sensors (not shown), at least one container sensor in each in each recess 75 adjacent each probe 14, 114. The container sensors are positioned within each of the recess 75 in cap 152 in the same manner as the container sensor 70 is positioned in the recess 75 of cap 12. The device 150 may be positioned or controlled by a machine or a user. The device 150 operates in the same manner as described above regarding device 10, 110 except that the multiple probes of device 150 can cure the photopolymer in multiple containers simultaneously by deploying the probes of device 150 in multiple respective containers simultaneously during each cycle of operation. Each of the cure lights of the multiple probes of device 150 illuminate simultaneously. The cap 152 can be moved to insert the plurality of probes, in a corresponding plurality of containers, which may be staged to receive the probes. Therefore, cure device 150 provides the efficient processing and curing of multiple containers, such as container 24, simultaneously. While device 150 shows 7 probes in FIGS. 10 and 11, any number of two or more probes can be provided for device 150 for curing a corresponding number of containers simultaneously.

In some embodiments, the controller 64 comprises processing circuitry. The processing circuitry may comprise one or more of microprocessor(s), microcontroller(s), a hardware circuit(s), application-specific integrated circuit(s) (ASIC), digital signal processor(s) (DSP), field-programmable gate array(s) (FPGA), discrete logic circuit(s), or combinations thereof for performing the operations of the controller 64 or the circuit 100.

From the foregoing, it will be observed that numerous variations and modifications may be affected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. Further, steps could be added or removed from the processes described. Therefore, other embodiments and implementations are within the scope of the invention.

The invention claimed is:

1. A cure device for curing photopolymer in a container, comprising:
a cap; and,
a probe extending from the cap, the probe comprising a plurality of cure lights.

2. The device of claim 1, wherein the plurality of cure lights are arranged in a plurality of columns of cure lights.

3. The device of claim 2, wherein the probe comprises a plurality of longitudinal sides, and at least one column of the plurality of columns of cure lights are located on each longitudinal side of the plurality of longitudinal sides.

4. The device of claim 3, wherein the plurality of longitudinal sides comprise four longitudinal sides.

5. The device of claim 3, wherein the plurality of longitudinal sides comprise six longitudinal sides.

6. The device of claim 5 wherein the probe comprises an elongated shaft and the shaft comprises the six longitudinal sides, the shaft comprises a hexagonal cross-section.

7. The device of claim 1, wherein the plurality of cure lights are arranged in a plurality of rows circumscribing the probe.

8. The device of claim 1, wherein the probe comprises an elongated shaft and a transparent cover over the shaft, the shaft comprises the plurality of cure lights.

9. The device of claim 1, wherein the probe is transverse to the cap.

10. The device of claim 1, wherein the cap comprises a container sensor positioned to detect a presence of a container at the cap.

11. The device of claim 1, wherein the cap comprises a bottom recess and a container sensor, the probe extends through the bottom recess.

12. The device of claim 11, wherein the container sensor is photoelectric sensor comprising an emitter and a receiver, the emitter is configured to emit a, emitted light, the receiver is positioned to detect the emitted light from the emitter.

13. The device of claim 1, comprising a controller configured to control an illumination of the plurality of cure lights.

14. The device of claim 1, comprising a container sensor and a controller, the controller configured to illuminate the plurality of cure lights of a predefined duration based on determining that the container sensor detects a container at the container sensor.

15. The device of claim 1, comprising a power source configured to power the plurality of cure lights.

16. The device of claim 1, wherein the plurality of cure lights emit a light having a wavelength in a range of 300 nanometers to 450 nanometers when powered.

17. The device of claim 1, wherein
the plurality of cure lights are arranged in a plurality of columns of cure lights and a plurality of rows circumscribing the probe;
the probe is elongated and extends transverse from a bottom of the cap;
the cap comprises a bottom recess and a photoelectric sensor, the probe extends through the bottom recess, the sensor comprises an emitter and a receiver, the emitter is positioned to direct an emitted light across the bottom recess to the receiver; the receiver is configured to detect the emitted light from the emitter;
the device comprises a controller that is configured to determine when a container is present at the cap based on an output from the sensor indicating container is present at the cap; and,
the plurality of cure lights are ultraviolet cure lights.

18. The device of claim 17, wherein
the probe comprises a shaft and a transparent cover over the shaft, the shaft comprises a plurality of longitudinal sides, and a least one column of the plurality of columns of cure lights are located on each longitudinal side of the plurality of longitudinal sides.

19. A method of curing photopolymer in a container, comprising the steps of:
inserting a probe of a cure device into an opening of the container and closing the opening with a cap of the cure device, the probe extends transverse from the cap;
illuminating a plurality of cure lights of the probe for a predefined duration of time.

20. A method of claim 19,
comprising the step of sensing a presence of the container at the cap with a sensor in the cap; and,
wherein the step of illuminating is further defined in that the plurality of cure lights on the probe are illuminated in response to sensing the presence of the container at the cap.
